(19) United States
(12) Patent Application Publication
(10) Pub. No.: US 2025/0390220 A1
(43) Pub. Date: Dec. 25, 2025

(54) ACCESS ACCELERATION SYSTEM FOR STORAGE DEVICE

(71) Applicant: SUZHOU METABRAIN INTELLIGENT TECHNOLOGY CO., LTD., Suzhou, Jiangsu (CN)

(72) Inventor: You Jyun JHANG, Suzhou, Jiangsu (CN)

(73) Assignee: SUZHOU METABRAIN INTELLIGENT TECHNOLOGY CO., LTD., Suzhou, Jiangsu (CN)

(21) Appl. No.: 18/879,725

(22) PCT Filed: Nov. 20, 2023
(86) PCT No.: PCT/CN2023/132744

§ 371 Date: Dec. 27, 2024

(30) Foreign Application Priority Data
Mar. 22, 2023 (CN) 202310285923.5

(51) Int. Cl. G06F 3/06

(52) U.S. Cl. CPC G06F 3/061; G06F 3/0655; G06F 3/0679

(57) ABSTRACT

Embodiments of the present disclosure provide an access acceleration system for storage devices. The system comprising: a central processing unit, a Peripheral Component Interconnect Express (PCIe) device, a storage device, a computing chip and memories, wherein: the PCIe device comprises a root complex device, a PCIe switch, and a PCIe endpoint; the central processing unit is in communication connection with an upstream port of the PCIe switch through the root complex device, the storage device is in communication connection with a downstream port of the PCIe switch, the computing chip is in communication connection with a downstream port of the PCIe switch through the PCIe endpoint, and the storage device and the computing chip are in communication connection with different downstream ports of the PCIe switch, respectively; and the central processing unit and the computing chip are electrically connected to different one of the memories.

### CROSS-REFERENCE TO RELATED APPLICATION

The present application is a National Stage Application of PCT International Application No.: PCT/CN2023/132744 filed on Nov. 20, 2023, which claims priority to Chinese Patent Application 202310285923.5, filed in the China National Intellectual Property Administration on Mar. 22, 2023, the disclosure of which is incorporated herein by reference in its entirety.

### TECHNICAL FIELD

Embodiments of the present disclosure relate to the field of computers, and in particular, to an access acceleration system for a storage device.

### BACKGROUND

In recent years, the Field Programmable Gate Array (FPGA) is used to accelerate inference and High Performance Computing (HPC) with more and more data centers in the fields of machine learning and big data, and FPGA provide low-latency acceleration functions, such as building design modeling, oil and natural gas searching, and nuclear power generation simulation. The FPGA reduces complex bottlenecks to share the workload of a central processing unit (CPU). Additionally, FPGA possess the capability to implement a hash algorithm (SHA), a de-duplication function, an error correction code, a compression, etc. Such an online processing method achieves dual computational advantages of the system architecture by freeing up limited processor memory while reducing the computational load on the processor. With this architecture, the CPU can reduce power consumption and operate at its optimal performance level, thereby enabling performance optimization for data centers.

Currently, the architecture in which a CPU is directly connected to devices is commonly used. All Peripheral Component Interconnect Express (PCIe) apparatuses are directly linked to an X86 system by means of a root complex of the CPU. All data to be transmitted must be read by the CPU and then allocated by the CPU to FPGA for processing. A server product typically has a very large number of external solid-state drives (Solid-State Drive, SSD), as well as many external PCIe devices. If the foregoing architecture is applied to a server, it will easily lead to a CPU frequently operating at full load, resulting in poor efficiency in system data processing.

### SUMMARY

Embodiments of the present disclosure provide an access acceleration system for storage devices, in order to at least address the problem in the related art that the architecture of an access acceleration system applied to storage devices easily leads to a CPU operating at full load.

Some embodiments of the present disclosure provide an access acceleration system for a storage device, including a central processing unit, a PCIe device, a storage device, a computing chip and memories; wherein the PCIe device includes a root complex device, a PCIe switch, and a PCIe endpoint; the central processing unit is in communication connection with an upstream port of the PCIe switch through the root complex device, the storage device is in communication connection with a downstream port of the PCIe switch, the computing chip is in communication connection with a downstream port of the PCIe switch through the PCIe endpoint, and the storage device and the computing chip are in communication connection with different downstream ports of the PCIe switch, respectively; and the central processing unit and the computing chip are electrically connected to different one of the memories.

In some exemplary embodiments, the access acceleration system further includes: a network interface card, in communication connection with a downstream port of the PCIe switch, wherein the network interface card, the storage devices, and the computing chip are in communication connection with different downstream ports of the PCIe switch, respectively.

In some exemplary embodiments, the access acceleration system includes at least one host unit and at least one computing unit, wherein: each host unit of the at least one host unit includes one said central processing unit, one said root complex device, and one memory; each computing unit of the at least one computing unit includes at least one said PCIe switch, a plurality of said storage devices, at least one said computing chip, at least one said PCIe endpoint, and at least one memory of the memories; each root complex device is in communication connection with the PCIe switch in at least one computing unit; and in each computing unit, each PCIe switch that is in communication connection with the root complex device is in communication connection with the plurality of storage devices, each computing chip is in communication connection with the at least one PCIe switch through the at least one PCIe endpoint, and the at least one computing chip is electrically connected one-to-one to the at least one memory.

In some exemplary embodiments, at least one of the at least one computing unit includes a plurality of PCIe switches and a plurality of computing chips, and in the same computing unit, the PCIe switches correspond to the computing chips on a one-to-one basis.

In some exemplary embodiments, each PCIe switch in the same computing unit is in communication connection with a root complex device; and in the same computing unit, a plurality of PCIe endpoints that are in communication connection with any one of the computing chips are in communication connection with a plurality of downstream ports of one of the PCIe switches on a one-to-one basis.

In some exemplary embodiments, the at least one PCIe switch in the each computing unit includes at least one first PCIe switch and at least one second PCIe switch, wherein each first PCIe switch of the at least one first PCIe switch has a first upstream port and a plurality of first downstream ports, the first upstream port being in communication connection with the root complex device, at least one of the first downstream ports being in communication connection with corresponding one computing chip of the at least one computing chip through at least one of the at least one PCIe endpoint, the at least one of the first downstream ports corresponding to the at least one of the at least one PCIe endpoint on a one-to-one basis, and each of the remaining first downstream ports being in communication connection with corresponding one of the storage devices; and each second PCIe switch of the at least one second PCIe switch has at least one second downstream port, each of the at least one second downstream port being in communication connection with corresponding one computing chip of the at least one computing chip through corresponding one of a portion of the at least one PCIe endpoint, the at least one second downstream port corresponding to the portion of the at least one PCIe endpoint on a one-to-one basis.

In some exemplary embodiments, the remaining first downstream ports of the each first second PCIe switch are in communication connection with the same number of storage devices.

In some exemplary embodiments, the at least one second downstream port of the each second PCIe switch is in communication connection with the corresponding one computing chip through the same number of PCIe endpoints.

In some exemplary embodiments, in the each computing unit, each computing chip of the at least one computing chip is in communication connection with corresponding one first PCIe switch of the at least one first PCIe switch through a plurality of first PCIe endpoints, and the each computing chip is in communication connection with a plurality of second PCIe switches of the at least one second PCIe switch through a plurality of second PCIe endpoints, the plurality of the second PCIe switches corresponding to the plurality of the second PCIe endpoints on a one-to-one basis.

In some exemplary embodiments, in the each computing unit, the numbers of the first PCIe endpoints and the second PCIe endpoints that are in communication connection with the same computing chip are same.

In some exemplary embodiments, in the each computing unit, the each computing chip is in communication connection with the same number of the first PCIe endpoints and the second PCIe endpoints.

In some exemplary embodiments, in the each computing unit, the number of second PCIe endpoints that are in communication connection with each of the second PCIe switches is the same as the number of the at least one computing chip.

In some exemplary embodiments, the access acceleration system further includes: fabric ports, each of the fabric ports being integrated into corresponding one of a plurality of PCIe switches of the at least one PCIe switch, the fabric ports being configured to support transmission between one PCIe switch into which a fabric port of the fabric ports is integrated and another PCIe switch into which a fabric port of the fabric ports is integrated.

In some exemplary embodiments, the at least one computing unit in the access acceleration system includes a plurality of first computing units, each of the first computing units has a first fabric port integrated into the first PCIe switch, and first fabric ports in different first computing units are in communication connection with each other.

In some exemplary embodiments, a first target computing unit of the plurality of first computing units is in communication connection with at least one second target computing unit among a plurality of first computing units except the first target computing unit through the first fabric port, and first fabric ports in the first target computing unit correspond to first fabric ports in the at least one each second target computing unit on a one-to-one basis.

In some exemplary embodiments, the at least one computing unit in the access acceleration system includes a plurality of second computing units, each of the second computing units has a second fabric port integrated into the second PCIe switch, and second fabric ports in different second computing units are in communication connection with each other.

In some exemplary embodiments, a third target computing unit of the plurality of second computing units is in communication connection with at least one fourth target computing unit among the plurality of second computing units except the third target computing unit through the second fabric port, and second fabric ports in the third target computing unit correspond to second fabric ports in the at least one fourth target computing unit on a one-to-one basis.

In some exemplary embodiments, the at least one computing unit in the access acceleration system includes a third computing unit, wherein the third computing unit has at least one first fabric ports integrated into the at least one first PCIe switch and at least one second fabric ports integrated into the at least one second PCIe switch, both the at least one first fabric ports and the at least one second fabric ports are switchable ports, and when a first fabric port of the at least one first fabric ports is switched to a second upstream port, and a second fabric port of the at least one second fabric ports is switched to a third downstream port, and at least one second fabric ports is switched to a third downstream port, at least one second upstream port is in communication connection with at least one third downstream port on a one-to-one basis.

In some exemplary embodiments, the at least one computing unit in the access acceleration system comprises a plurality of third computing units, the second PCIe switch is integrated with the switchable ports and a third fabric port, and third fabric ports in different third computing units are in communication connection with each other.

In some exemplary embodiments, the fifth target computing unit of the plurality of third computing units is in communication connection with at least one sixth target computing unit among the plurality of third computing units except the fifth target computing unit through the third fabric port, and third fabric ports in the fifth target computing unit correspond to third fabric ports in the at least one sixth target computing unit on a one-to-one basis.

In the present disclosure, the computing chip (such as FPGA) and the storage device (such as Non-Volatile Memory Express Solid-State Drives (Non-Volatile Memory Express Solid-State Drive, NVMe SSD)) can not only traditionally transmit data in a manner of being directly connected to a central processing unit (CPU), but also can achieve point-to-point transmission between the computing chip such as FPGA and the storage device such as NVMe SSD by means of a storage accelerate architecture (SAA) in this embodiment, thereby achieving a direct memory access (DMA) function. Since DMA is a technology that allows direct access memory, it enables hardware subsystems to independently and directly read and write memory, without the need for a CPU to intervene for processing. CPU resources can be freed to other applications by means of the SAA, and the computing chip such as FPGA can independently handle the pre-processing and post-processing of data. Each FPGA is a drive engine for data processing, and computing resources are added to each drive of the server, thereby reducing the load of the CPU and allowing a larger number of PCIe devices to be used. Therefore, the problem in the related art that an SAA applied to storage devices easily leads to a CPU operating at full load can be solved, thereby achieving the effects of reducing the load of the CPU and allowing a larger number of PCIe devices to be used.

### BRIEF DESCRIPTION OF THE DRAWINGS

FIG. 1 is a block diagram of the architecture of an access acceleration system for a storage device in the related art;

FIG. 2 is a block diagram of the architecture of an access acceleration system in which transmission data is directly connected to a central processing unit according to some embodiments of the present disclosure;

FIG. 3 is a block diagram of the architecture of an access acceleration system that data is point-to-point transmitted between a computing chip and storage devices according to some embodiments of the present disclosure;

FIG. 4 is a block diagram of the architecture of an access acceleration system for a storage device having multiple groups of host units and computing units according to some embodiments of the present disclosure;

FIG. 5 is a block diagram of the architecture of an access acceleration system for a storage device having a plurality of first PCIe switches according to some embodiments of the present disclosure;

FIG. 6 is a block diagram of the architecture of an access acceleration system for a storage device having multiple groups of host units and computing units according to some other embodiments of the present disclosure;

FIG. 7 is a block diagram of the architecture of an access acceleration system for a storage device having multiple groups of host units and computing units according to some other embodiments of the present disclosure;

FIG. 8 is a block diagram of the architecture of an access acceleration system for a storage device having multiple groups of host units and computing units according to some other embodiments of the present disclosure; and

FIG. 9 is a block diagram of the architecture of each group of host unit and computing unit in the system shown in FIG. 8.

### DETAILED DESCRIPTION OF THE EMBODIMENTS

In order to enable a person skilled in the art to understand the solutions of the present disclosure better, hereinafter, the technical solutions in the embodiments of the present disclosure will be described clearly and thoroughly with reference to the accompanying drawings of embodiments of the present disclosure. Obviously, the embodiments as described are only some embodiments of the present disclosure, and are not all the embodiments. All other embodiments obtained by a person of ordinary skill in the art on the basis of the embodiments of the present disclosure without involving any inventive effort shall all fall within the scope of protection of the present disclosure.

It should be noted that the terms “first”, “second”, etc., in the description, claims, and accompanying drawings of the present disclosure are used to distinguish similar objects, and are not necessarily used to describe a specific sequence or order. It should be understood that the data so used may be interchanged where appropriate so that the embodiments of the present disclosure described herein can be implemented in sequences other than those illustrated or described herein. In should be noted that terms “include” and “have” and any variations thereof are intended to cover a non-exclusive inclusion, for example, a process, method, system, product or device which includes a series of steps or units is not necessarily limited to those steps or units that are clearly listed, but may include other steps or units that are not clearly listed or inherent to these process, method, product or device.

For ease of description, some nouns or terms involved in embodiments of the present disclosure are described as follows:
Peripheral Component Interconnect Express Enumeration: PCIe for short, for example, a HOST acquires a complete PCIe device topology structure using a PCIe enumeration process;
Direct Memory Access: DMA for short, which is a memory access technology of the computer science, and allows hardware subsystems to independently and directly read and write system memory without the need for a central processing unit to intervene for processing;
Root Complex: an apparatus connects a processor and a memory subsystem to a PCI Express switching structure consisting of one or more switching apparatuses; and
EndPoint: it is referred to as a PCIe endpoint in the present disclosure.

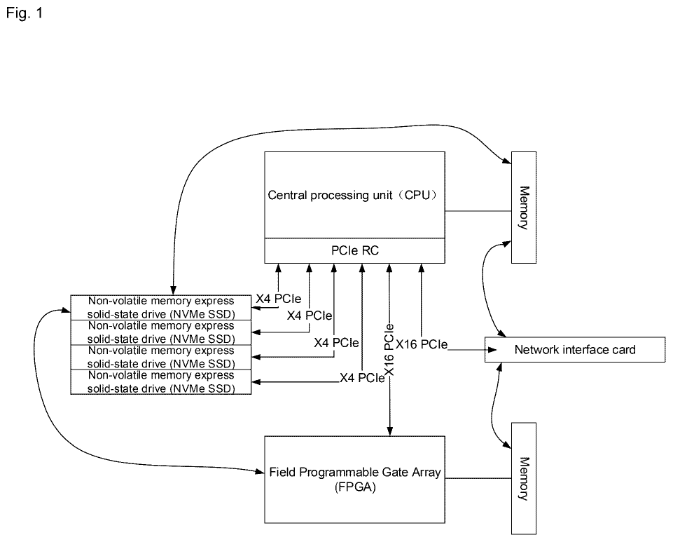

FIG. 1 shows an architecture of a CPU directly connected to devices in the related art, the architecture including a CPU, a root complex, peripheral components and memories, the peripheral components including a field programmable gate array (FPGA), NVMe Solid-State Drives (NVMe SSDs) and a network interface card (NIC), wherein all PCIe apparatuses are directly linked to an X86 system via a PCIe link by means of the PCIe root complex. All data to be transmitted must be read by the CPU and then allocated by the CPU to the FPGA for processing; however, a server product typically has a very large number of external SSDs, as well as many external PCIe devices. If the foregoing architecture is applied to a server, it will easily lead to the CPU operating at full load, resulting in poor efficiency in system data processing.

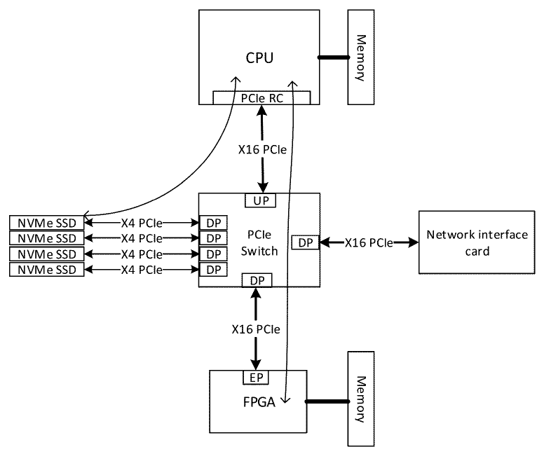

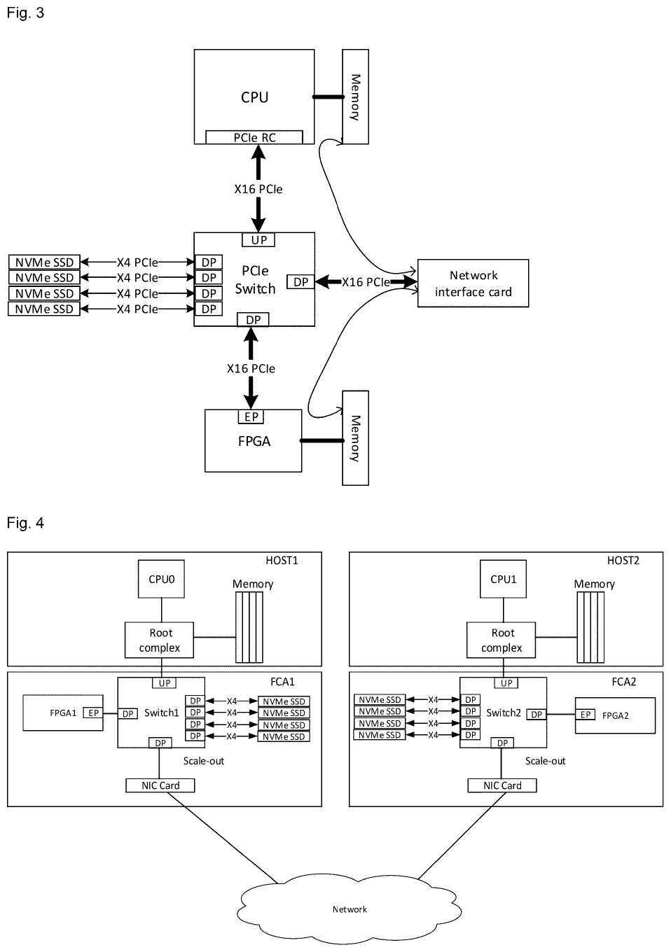

Some embodiments of the present disclosure provide an access acceleration system for a storage device. FIG. 2 is a block diagram of the architecture of an access acceleration system for a storage device according to embodiments of the present disclosure. As shown in FIGS. 2 and 3, including a central processing unit, a PCIe device, a storage device, a computing chip, and memories.

The PCIe device includes a root complex device, a PCIe switch and a PCIe endpoint. The central processing unit is in communication connection with an upstream port of the PCIe switch through the root complex device, the storage device is in communication connection with a downstream port of the PCIe switch, the computing chip is in communication connection with a downstream port of the PCIe switch through the PCIe endpoint, and the storage device and the computing chip are in communication connection with different downstream ports of the PCIe switch, respectively. The central processing unit and the computing chip are electrically connected to different one of the memories.

According to this embodiment, the computing chip such an FPGA and the storage device (such as solid-state drive) can not only traditionally transmit data in a manner of being directly connected to a CPU (as shown in FIG. 2), but also achieve point-to-point transmission between a computing chip such as FPGA and the storage device using a storage accelerate architecture (SAA) in this embodiment (as shown in FIG. 3), thereby achieving a direct memory access (DMA) function. Since DMA is a technology that allows direct access memory, it enables hardware subsystems to independently and directly read and write memory, without the need for a CPU to intervene for processing. CPU resources can be freed to other applications by means of the SAA, and a computing chip such as an FPGA can independently handle the pre-processing/post-processing of data. Each FPGA is a drive engine for data processing, and computing resources are added to each drive of the server, thereby reducing the load of the CPU and allowing a larger number of PCIe devices to be used. Therefore, the problem in the related art that the architecture of an access acceleration system applied to storage devices easily leads to the CPU operating at full load is solved, thereby achieving the effects of reducing the load of the CPU and allowing a larger number of PCIe devices to be used.

By means of the foregoing SAA, point-to-point transmission between a computing chip and storage devices is achieved, thereby achieving a DMA function. A computing chip and storage devices can directly read and write memory independently without the intervention of a CPU, resources of the CPU are freed to other applications via an SAA, and the computing chip can independently handle the pre-processing/post-processing of data. Each computing chip is a drive engine for data processing, and computing resources are added to each driver of the server, thereby reducing the load of the CPU, and allowing a larger number of PCIe devices to be used, thereby processing a larger database.

In some exemplary embodiments, the storage device may be a solid-state drive, such as NVMe solid-state drive (NVMe SSD), and the computing chip may be a field programmable gate array (FPGA). Data transmission of an FPGA accelerator uses an internal data path and saves valuable DRAM bandwidth. It can be extended without expensive x86 systems by means of this method, avoiding unnecessary data movement of an independent FPGA accelerator, and data in storage devices can be securely point-to-point transmitted from the storage devices to an FPGA. However, the present disclosure is not limited to the foregoing types, for example, the computing chip may also be a general-purpose computing on graphics processing unit (General-Purpose Computing On Graphics Processing Unit, GPGPU), which is not specifically limited in this embodiment.

In some exemplary embodiments, the access acceleration system further includes a network interface card (NIC), in communication connection with a downstream port of the PCIe switch, wherein the network interface card, the storage devices, and the computing chip are in communication connection with different downstream ports of the PCIe switch, respectively.

Optionally, as shown in FIG. 3, not only can point-to-point transmission be achieved between the FPGA and the NVMe SSD by means of the SAA, but the NIC can also achieve point-to-point transmission of data by means of the SAA, thereby achieving the DMA function.

In some exemplary embodiments, the access acceleration system may include at least one host unit and at least one computing unit, wherein: each host unit of the at least one host unit includes one said central processing unit, one said root complex device, and one memory of the memories; each computing unit of the at least one computing unit includes at least one said PCIe switch, a plurality of said storage devices, at least one said computing chip, at least one said PCIe endpoint, and at least one memory of the memories; each root complex device is in communication connection with a PCIe switch in at least one computing unit; and in the each computing unit, each PCIe switch that is in communication connection with the root complex device is in communication connection with the plurality of storage devices, each computing chip is in communication connection with the at least one PCIe switch through the at least one PCIe endpoint, and the at least one computing chip is electrically connected one-to-one to the at least one memory.

Optionally, taking the described computing chip being an FPGA as an example, the described computing unit can be referred to as an FPGA Computing Appliance (FCA). By means of the characteristic that the FPGA in the FCA can independently process data, an additional amount of data movement is reduced, and the purpose of point-to-point acceleration data processing of a plurality of storage devices (such as NVMe SSDs) is achieved by means of the FPGA, thereby assisting storage acceleration on the storage devices such as NVMe SSDs in the system.

Furthermore, when the access acceleration system includes a plurality of host units and a plurality of computing units, the parallel processing technology between a plurality of FCAs connected to the same HOST unit can also enable scale-out of data processing speed, and the FPGA parallel processing technology of the FCAs is used to achieve massive data synchronization processing. Furthermore, by increasing the number of FPGAs supported by the system, the computing capability of the single system may be maximized.

In some exemplary embodiments, the access acceleration system may include a plurality of host units and a plurality of computing units which are connected on one-to-one basis. A star-link topology is used to connect a plurality of HOST units, so that the system is more resilient in expansion; the plurality of HOST units form a distributed cluster system to mitigate data processing risks and expand the processing capability; and when the performance of a single system reaches its limit, scale-out can be used to overcome the hardware limitation of the single system.

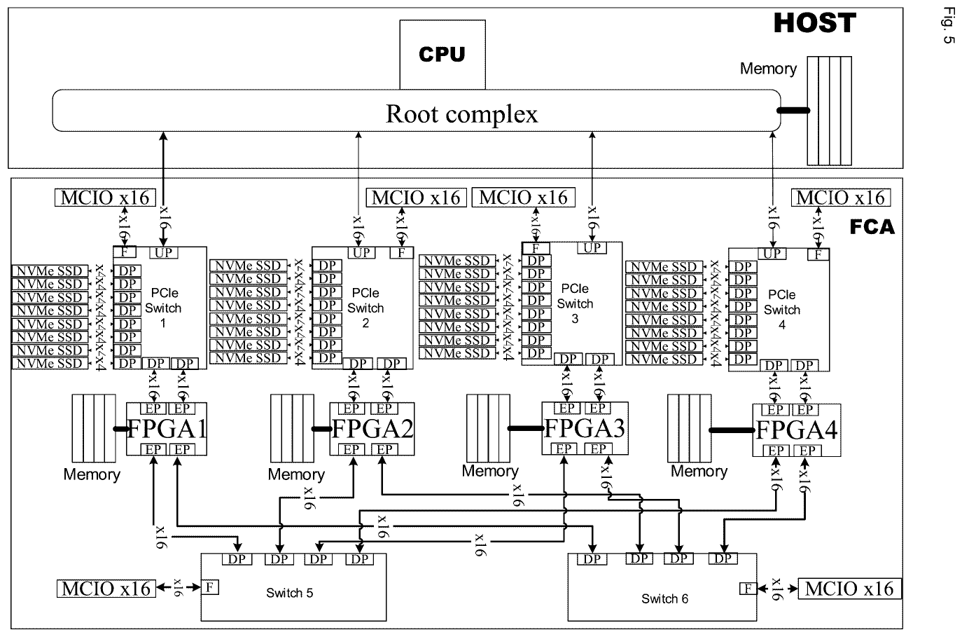

Optionally, taking that the access acceleration system comprises a plurality of HOST units and a plurality of computing units (FCA) connected in one-to-one correspondence as an example, as shown in FIG. 4, the HOST units and the FCAs may be connected via PCIe interfaces, and are connected to other HOST units via NICs (namely, NIC card), thereby achieving the purpose of parallel upgrading. After a downstream port of a PCIe switch is connected to an NIC, a data packet between servers may be transmitted via the network, and the entire network comprises a plurality of data nodes (HOST1, HOST2, Switch1, and Switch2), wherein HOST1 has a CPU0, HOST2 has a CPU1, and the data packet may flow through any two computing nodes on the path and an FPGA that comprises a downstream port of the switch. The switch 1 in the FCA1 and the switch 2 in the FCA2 are respectively connected to data of the external NVMe SSD, and can transmit the data to the FPGA via the network for preprocessing. The number of FPGAs supported by the system can be increased by multiple, and the capacity of the NVMe SSD supported by the system can also be increased by multiple, thereby achieving the purposes of increased storage capacity and processing speed of the FPGA, and the horizontal expansion of the system.

Optionally, a plurality of PCIe switches in different systems may be connected to the network via NICs, respectively, achieving horizontal expansion between the systems.

In some exemplary embodiments, at least one of at least one computing unit may include a plurality of PCIe switches and a plurality of computing chips, and in the same computing unit, the PCIe switches correspond to the computing chips on a one-to-one basis.

Optionally, taking the foregoing computing chips being FPGAs as an example, the plurality of PCIe switches in the computing unit are connected to the CPU by means of a root complex device in the HOST unit, and the plurality of FPGAs in communication connection with the plurality of PCIe switches for parallel connection, achieving massive data synchronization processing by means of the FPGA parallel processing technology.

In the foregoing exemplary embodiments, each PCIe switch in the same computing unit may be in communication connection with a root complex device; furthermore, in the same computing unit, a plurality of PCIe endpoints (EndPoint, EP) in communication connection with any one computing chip may be used to implement communication connection with a plurality of downstream ports of one of the PCIe switches on a one-to-one basis.

In some exemplary embodiments, the at least one PCIe switch in the each computing unit includes at least one first PCIe switch and at least one second PCIe switch, wherein each first PCIe switch of the at least one first PCIe switch has a first upstream port and a plurality of first downstream ports, the first upstream port being in communication connection with the root complex device, at least one of the first downstream ports being in communication connection with corresponding one computing chip of the at least one computing chip through at least one of the at least one PCIe endpoint, the at least one of the first downstream ports corresponding to the at least one of the at least one PCIe endpoint on a one-to-one basis, and each of the remaining first downstream ports being in communication connection with corresponding one of the storage devices; and each second PCIe switch of the at least one second PCIe switch has at least one second downstream port, each of the at least one second downstream port being in communication connection with corresponding one computing chip of the at least one computing chip through corresponding one of a portion of the at least one PCIe endpoint, the at least one second downstream port corresponding to the portion of the at least one PCIe endpoint on a one-to-one basis.

Optionally, taking the foregoing computing chips being FPGAs as an example, a plurality of first PCIe switches in the computing unit may be connected to a CPU via one root complex device in the HOST unit, a plurality of FPGAs are in communication connection with the first downstream ports of the plurality of first PCIe switches by means of PCIe endpoints for parallel connection, and the second downstream ports of the plurality of second PCIe switches each are in communication connection with each FPGA via the PCIe endpoint, thereby achieving massive data synchronization processing by means of the FPGA parallel processing technology.

In the foregoing exemplary embodiments, the remaining first downstream ports of the each first PCIe switch may be in communication connection with the same number of storage devices.

In the foregoing exemplary embodiments, at least one second downstream port of the each second PCIe switch is in communication connection with the corresponding one computing chip through the same number of PCIe endpoints.

In some exemplary embodiments, in the each computing unit, each computing chip of the at least one computing chip is in communication connection with corresponding one first PCIe switch of the at least one first PCIe switch through a plurality of first PCIe endpoints, and the each computing chip is in communication connection with a plurality of second PCIe switches of the at least one second PCIe switch through a plurality of second PCIe endpoints, the plurality of the second PCIe switches corresponding to the plurality of the second PCIe endpoints on a one-to-one basis.

Optionally, taking the foregoing computing chips being FPGAs as an example, a plurality of first PCIe switches in a computing unit may be connected to a CPU by means of one root complex device in the HOST unit, each FPGA is in communication connection with a plurality of first downstream ports of one first PCIe switch by means of a plurality of PCIe endpoints for parallel connection, and a plurality of second downstream ports of each second PCIe switch are in communication connection with each FPGA by means of a plurality of PCIe endpoints, thereby achieving massive data synchronization processing by means of the FPGA parallel processing technology.

Optionally, a resilient change of system expansion may also be added by using an MCIO (Mini Cool Edge IO) connector, so as to maximally improve the data processing capability of the system.

In the foregoing exemplary embodiments, in the each computing unit, the numbers of the first PCIe endpoints and the second PCIe endpoints that are in communication connection with the same computing chip are same.

In some exemplary embodiments, in the each computing unit, the each computing chip is in communication connection with the same number of the first PCIe endpoints and the second PCIe endpoints, respectively.

In some exemplary embodiments, in the each computing unit, the number of second PCIe endpoints that are in communication connection with each of the second PCIe switches is the same as the number of the at least one computing chip.

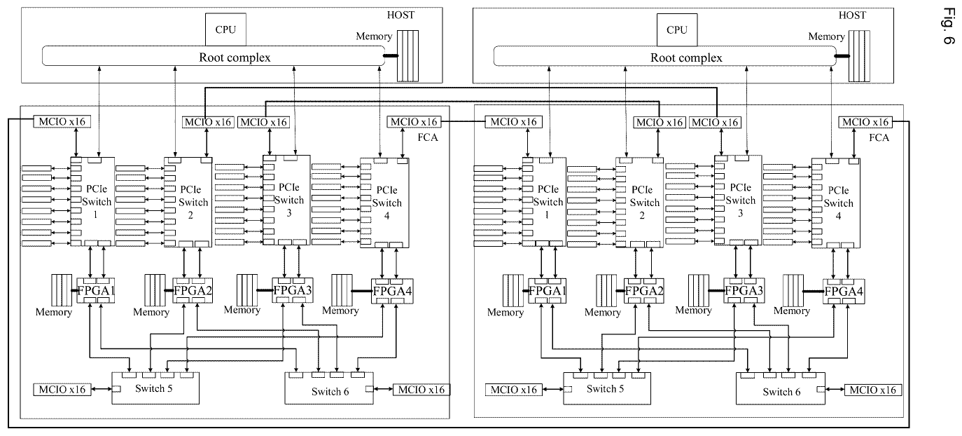

Optionally, taking that the foregoing computing unit comprises a plurality of computing chips as an example, as shown in FIG. 5, a plurality of first PCIe switches (PCIe Switch 1, PCIe Switch 2, PCIe Switch 3 and PCIe Switch 4) are configure that a set of x16 lanes upstream ports are connected to the root complex in the HOST unit, two sets of x16 lanes downstream ports are connected to two sets of the endpoints of the FPGA, and eight sets of x4 lanes downstream ports are connected to the endpoints of the NVMe SSDs; and a plurality of second PCIe switches (PCIe Switch 5, and PCIe Switch 6) are configured that four sets of x16 lanes downstream ports are respectively connected to four sets of endpoint of four FPGAs, thereby achieving massive data synchronization processing by means of the FPGA parallel processing technology.

Optionally, the plurality of FPGAs can use an Ultra Path Interconnect (UPI) interface thereof to achieve the FPGA interconnect characteristic, enabling resilient resource allocation and information sharing between FPGAs, making the system more efficient and convenient.

In some exemplary embodiments, the access acceleration system further includes fabric ports, which are integrated into the plurality of PCIe switches, and configured to support transmission between one PCIe switch and another PCIe switch which are integrated with the fabric ports.

Optionally, a fabric port is integrated into corresponding one of a plurality of PCIe switches of the at least one PCIe switch, so that the PCIe switch becomes a PCIe switch supporting the fabric port. A main function of the fabric port is to support mutual transmission between the PCIe switches, and has an I/O sharing function and a DMA with characteristics such as non-blocking and linear acceleration.

Optionally, taking the architecture of the access acceleration system shown in FIG. 5 as an example, in this case, a set of x16 lanes fabric ports may be connected to the MCIO connector for resilient operation.

In some exemplary embodiments, the at least one computing unit in the system includes a plurality of first computing units, each of the first computing units has a first fabric port integrated into the first PCIe switch, and first fabric ports in different first computing units are in communication connection with each other.

Optionally, the PCIe switch may configure a port of the first PCIe switch to be a fabric port, and the fabric port may connect PCIe devices under multiple systems to each other by means of end points, so that a PCIe topology can be extended in a manner of low latency and high performance, and resources (FPGA, NVMe SSD, and NIC) can be dynamically allocated to different hosts in this manner.

In the foregoing exemplary embodiments, a first target computing unit of the plurality of first computing units is in communication connection with at least one second target computing unit among the plurality of first computing units except the first target computing unit through the first fabric port, and first fabric ports in the first target computing unit correspond to first fabric ports in each second target computing unit on a one-to-one basis.

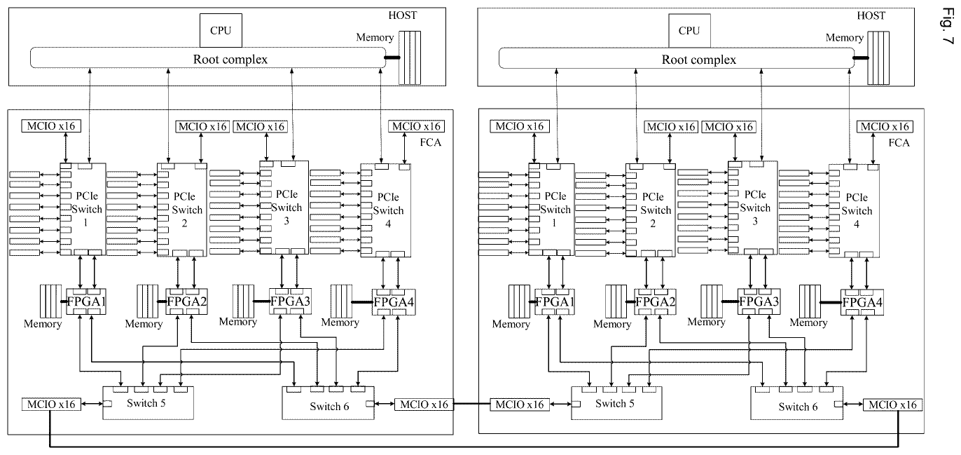

Optionally, taking the architecture of the access acceleration system shown in FIG. 6 as an example, the architecture includes multiple groups of host units (HOST) and computing units (FCA), each group of HOSTs and FCAs is as shown in FIG. 5, the HOST in the same group is linked to the first PCIe switch in the FCA by means of a root complex, and each FCA comprises a plurality of first PCIe switches (PCIe Switch 1, PCIe Switch 2, PCIe Switch 3, and PCIe Switch 4). Fabric ports of the PCIe Switch 1, PCIe Switch 2, PCIe Switch 3 and PCIe Switch 4 are connected to fabric ports of a PCIe Switch 1, PCIe Switch 2, PCIe Switch 3 and PCIe Switch 4 in another FCA, so that by means of the characteristic that PCIe devices of the fabric ports are connected with each other via end points, two systems can share NVMe SSDs connected thereto, realizing dynamic allocation of the NVMe SSDs.

Optionally, the plurality of FPGAs can use an Ultra Path Interconnect (UPI) interface thereof to achieve the FPGA interconnect characteristic, enabling resilient resource allocation and information sharing between FPGAs, making the system more efficient and convenient.

In some exemplary embodiments, the at least one computing unit in the system includes a plurality of second computing units, each of the second computing units has a second fabric port integrated into the second PCIe switch, and second fabric ports in different second computing units are in communication connection with each other.

Optionally, the PCIe switch may also configure a port of the second PCIe switch to be a fabric port, and the fabric port may connect PCIe devices under multiple systems to each other by means of end points, so that a PCIe topology can be extended in a manner of low latency and high performance, and resources (FPGA, NVMe SSD, and NIC) can be dynamically allocated to different hosts in this manner.

In the foregoing exemplary embodiments, a third target computing unit of the plurality of second computing units is in communication connection with at least one fourth target computing unit among the plurality of second computing units except the third target computing unit through the second fabric port, and second fabric ports in the third target computing unit correspond to second fabric ports in the at least one fourth target computing unit on a one-to-one basis.

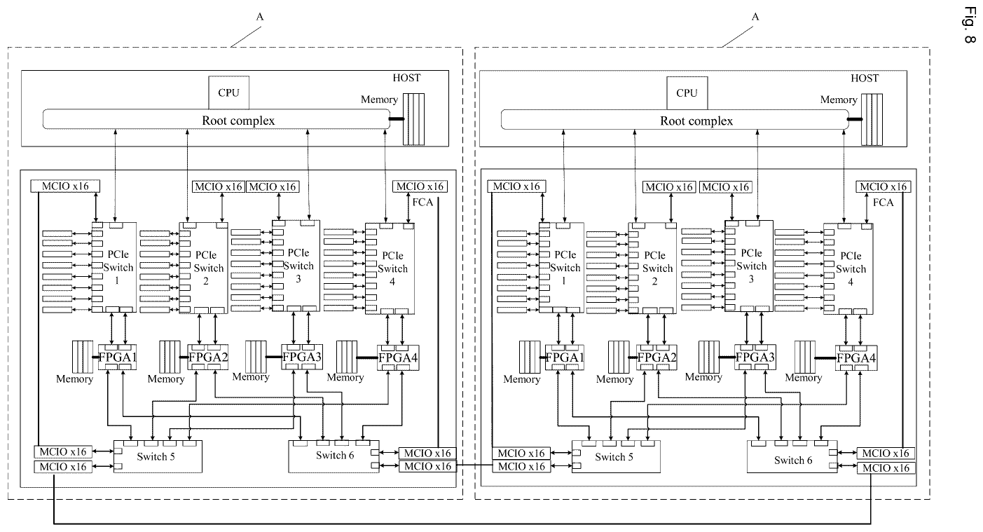

Optionally, taking the architecture of the access acceleration system shown in FIG. 7 as an example, the architecture comprises multiple groups of host units (HOST) and computing units (FCA), each group of HOSTs and FCAs is as shown in FIG. 5, the HOST in the same group is linked to the first PCIe switch in the FCA by means of a root complex, each computing unit (FCA) in the system comprises a plurality of second PCIe switches (PCIe Switch 5, and PCIe Switch 6), and an interconnect mechanism of the plurality of systems is achieved by using the fabric ports of the Switch 5 and Switch 6 of the plurality of FCAs via an MCIO cable. Each FCA has a plurality of FPGAs, and by dynamically allocating resources, resources in the FPGAs can be evenly allocated, which in turn speeds up the processing of large amounts of data. The MCIO cable may also be used as a more resilient system.

Optionally, the plurality of FPGAs can use an Ultra Path Interconnect (UPI) interface thereof to achieve the FPGA interconnect characteristic, enabling resilient resource allocation and information sharing between FPGAs, making the system more efficient and convenient.

In some exemplary embodiments, the at least one computing unit in the system includes a third computing unit, the third computing unit has at least one first fabric ports integrated into the at least one first PCIe switch and at least one second fabric ports integrated into the at least one second PCIe switch, both the at least one first fabric ports and the at least one second fabric ports are switchable ports, and when a first fabric port of the at least one first fabric ports is switched to a second upstream port, and a second fabric port of the at least one second fabric ports is switched to a third downstream port, and at least one second fabric ports is switched to a third downstream port, at least one second upstream port is in communication connection with at least one third downstream port on a one-to-one basis.

Optionally, the first fabric port may be dynamically switched to the second upstream port, and the second fabric port may be dynamically switched to the third downstream port, achieving communication connection between the first PCIe switch and the second PCIe switch which have the foregoing switchable ports via the second fabric port and the third downstream port.

In the foregoing exemplary embodiments, the at least one computing unit in the system includes a plurality of third computing units, the second PCIe switch is integrated with the switchable ports and a third fabric port, and third fabric ports in different third computing units are in communication connection with each other.

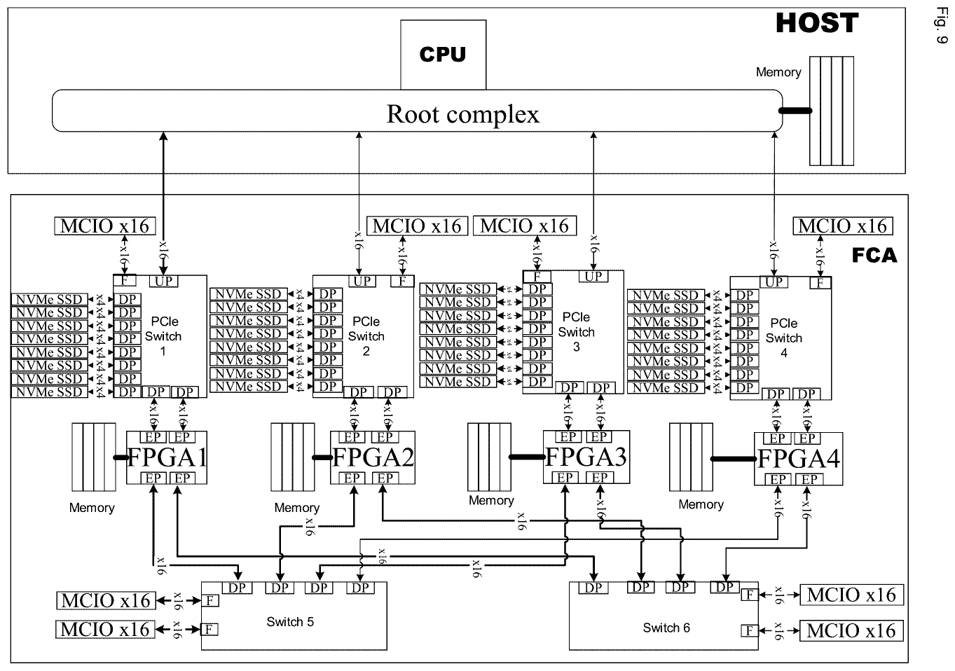

Optionally, taking the architecture of the access acceleration system shown in FIG. 8 as an example, the architecture comprises multiple groups of host units (HOST) and computing units (FCA), and the HOST in the same group is linked to the first PCIe switch in the FCA by means of a root complex. FIG. 9 shows the HOST and the FCA in any area A in FIG. 8, two FCAs in the system each comprise four first PCIe switches (PCIe Switch 1, PCIe Switch 2, PCIe Switch 3, and PCIe Switch 4), and two second PCIe switches (PCIe Switch 5, and PCIe Switch 6). A port of an MCIO X16 connector to which the PCIe Switch 1 and the PCIe Switch 4 are connected is dynamically switched from a fabric port to a downstream port, then one port of the PCIe Switch 5 and the PCIe Switch 6 is switched to an upstream port, and the two ports are connected together by using an MCIO cable, so that the PCIe Switch 1 and the PCIe Switch 5 form a cascade PCIe topology with the PCIe Switch 2 and the PCIe Switch 6, and in this case, the HOST unit can directly perform task allocation to four groups of endpoints of the FPGA at the same time.

In the foregoing exemplary embodiments, a fifth target computing unit of the plurality of third computing units is in communication connection with at least one sixth target computing unit among the plurality of third computing units except the fifth target computing unit through the third fabric port, and third fabric ports in the fifth target computing unit correspond to third fabric ports in the at least one sixth target computing unit on a one-to-one basis.

Optionally, taking the architecture of the access acceleration system shown in FIGS. 8 and 9 as an example, two FCAs in the system each comprise four first PCIe switches (PCIe Switch 1, PCIe Switch 2, PCIe Switch 3, and PCIe Switch 4), and two second PCIe switches (PCIe Switch 5, and PCIe Switch 6), in which fabric ports of the PCIe Switch 5 and the PCIe Switch 6 are connected to a PCIe Switch 5 and a PCIe Switch 6 in another host unit via MCIO cables, so that a star-link interconnect topology of systems of two host units is achieved, and when one HOST unit has a computing task, any group of FPGAs can be allocated via a fabric port, so as to achieve dynamic resource allocation, thereby increasing the computing capacity of a system computing unit; and the task and the data are allocated so as to achieve multi-task computing, and the resource can be optimized maximally.

Hereinafter, the foregoing access acceleration system for storage devices in the present disclosure will be further described with reference to specific embodiments.

As shown in FIG. 4, the architecture of the access acceleration system in the embodiments comprises two HOST units and two computing units (FCA1, FCA2) which are correspondingly connected on a one-to-one basis, wherein the HOST units and the FCAs may be connected via PCIe interfaces, and are connected to other HOST units via NICs, thereby achieving parallel upgrading. Optionally, a plurality of PCIe switches in different systems are connected to a network via NICs to implement horizontal expansion between the systems.

When a downstream port of a PCIe switch is connected to an NIC, a data packet between servers may be transmitted via the network; the entire network comprises a plurality of data nodes (HOST1, Switch1, Switch2, and HOST2), and the data packet may flow through any two computing nodes on a path and an FPGA that comprises a downstream port of the switch.

The FCA1 and the FCA2 are connected to each other, data of external NVMe SSDs of the FCTs can be transmitted to the FPGAs via the network for pre-processing, thereby the number of FPGAs supported by the system can be increased by multiple, and the capacity of the NVMe SSDs supported by the system is also increased by multiple, achieving the purposes of increased storage capacity and processing speed of the FPGAs, and horizontal expansion of the system.

As shown in FIG. 5, the architecture of the access acceleration system in this embodiment comprises four computing chips (FPGA1, FPGA2, FPGA3, and FPGA4), the four first PCIe switches (PCIe Switch 1, PCIe Switch 2, PCIe Switch 3, and PCIe Switch 4) are configured that s set of x16 lanes upstream ports are connected to a root complex in the HOST unit, two sets of x16 lanes downstream ports are connected to two sets of endpoints of the FPGAs, eight sets of x4 lanes downstream ports are connected to endpoints of the NVMe SSDs; and a plurality of second PCIe switches (PCIe Switch 5, and PCIe Switch 6) are configured that four sets of x16 lanes downstream ports are connected to four sets of endpoints of the four FPGAs, respectively, and a set of x16 lanes fabric ports may be connected to the MCIO connector for resilient operation.

As shown in FIG. 6, the architecture of the access acceleration system in this embodiment comprises two groups of HOSTs and FCAs, the HOST in the same group is linked to the first PCIe switch in the FCA by means of a root complex, and each FCA comprises:
four first PCIe switches (PCIe Switch 1, PCIe Switch 2, PCIe Switch 3, and PCIe Switch 4) and two second PCIe switches (PCIe Switch 5, and PCIe Switch 6), in which fabric ports of the PCIe Switch 1, PCIe Switch 2, PCIe Switch 3 and PCIe Switch 4 are interconnected with Fabric ports of a PCIe Switch 1, PCIe Switch 2, PCIe Switch 3 and PCIe Switch 4 in another FCA.

By means of the characteristic that PCIe devices of fabric ports are connected to each other by means of end points, two groups of systems can share the external NVMe SSDs, thereby realizing dynamic allocation of the NVMe SSDs; furthermore, by dynamical allocation of resources, the resources in the FPGA can be allocated in balance, facilitating accelerating the processing of a huge amount of data. The MCIO cable may also be used as a more resilient system.

As shown in FIG. 7, the architecture of the access acceleration system in this embodiment includes two groups of HOSTs and FCAs, the HOST in the same group is linked to the first PCIe switch in the FCA by means of a root complex, and each FCA includes:
four first PCIe switches (PCIe Switch 1, PCIe Switch 2, PCIe Switch 3, and PCIe Switch 4), and two second PCIe switches (PCIe Switch 5, and PCIe Switch 6), and an interconnect mechanism of two systems is implemented by using fabric ports of the Switch 5 and Switch 6 of two FCAs via MCIO cables, wherein each of the two groups of FCAs has four FPGAs.

By means of the characteristic that PCIe devices of fabric ports are connected to each other by means of end points, two groups of systems can share the external NVMe SSDs, thereby realizing dynamic allocation of the NVMe SSDs; in addition, by dynamical allocation of resources, the resources in the FPGA can be allocated in balance, facilitating accelerating the processing of a huge amount of data. The MCIO cable may also be used as a more resilient system.

As shown in FIGS. 8 and 9, the architecture of the access acceleration system in this embodiment includes two groups of HOSTs and FCAs, the HOST in the same group is linked to the first PCIe switch in the FCA by means of a root complex, and each FCA includes four first PCIe switches (PCIe Switch 1, PCIe Switch 2, PCIe Switch 3, and PCIe Switch 4) and two second PCIe switches (PCIe Switch 5, and PCIe Switch 6).

A port of an MCIO X16 connector to which the PCIe Switch 1 and the PCIe Switch 4 are connected is dynamically switched from a fabric port to a downstream port, then one port of the PCIe Switch 5 and the PCIe Switch 6 is switched to an upstream port, and the two ports are connected together by using an MCIO cable, so that the PCIe Switch 1 and the PCIe Switch 5 form a cascade PCIe topology with the PCIe Switch 2 and the PCIe Switch 6, and in this case, the HOST unit can directly perform task allocation to four groups of endpoints of the FPGA at the same time.
fabric ports of the PCIe Switch 5 and the PCIe Switch 6 are connected to a PCIe Switch 5 and a PCIe Switch 6 in another HOST unit via MCIO cables, so that a star-link interconnect topology of systems of two host units is achieved, and when one HOST unit has a computing task, any group of FPGAs can be allocated via a fabric port, so as to achieve dynamic resource allocation, thereby increasing the computing capacity of a system computing unit; and the task and the data are allocated so as to achieve multi-task computing, and the resource can be optimized maximally.

From the description above, it can be determined that the embodiments of the present disclosure achieve the following technical effects:

The present embodiment leverages the characteristic of storage devices being capable of independent data processing to reduce additional data movement; and by utilizing computing chips (such as FPGAs), point-to-point accelerated data processing of storage devices (such as NVMe SSDs) is achieved, thereby assisting SSDs in the system to perform storage acceleration;
a computing chip parallel processing technology of a computing unit (when the computing chip is an FPGA, the computing unit is an FPGA computing appliance (FCA)) is used to achieve massive data synchronization processing, and a parallel processing technology between the computing units is used for the scale-out of data processing speed, so that the computing capacity of a single system can be maximized by increasing the number of computing chips supported by the system;
a star-link topology is used to link a plurality of HOST units, so that the system is more resilient in expansion; the plurality of HOST units form a distributed cluster system to mitigate data processing risks and expand the processing capability; and when the performance of a single system reaches its limit, scale-out can be used to overcome the hardware limitation of the single system;
by means of a storage accelerate architecture (SAA), point-to-point transmission is achieved between computing chips and storage devices, and a network interface card (NIC) can also leverage the SAA architecture to enable point-to-point data transmission, thereby a DMA function can be achieved; and
system latency is reduced and performance bottlenecks associated with scale-up scenarios is overcome; in particular, multiple HOST units allow multiple computing processors to handle diverse and complex computational problems simultaneously, maximizing the system's data processing capability; in addition, the redundancy mechanisms of the multiple HOST units enhance system stability, significantly improving system reliability and resilience.

For specific examples in the present embodiment, reference can be made to the examples described in the described embodiments and exemplary embodiments, and thus they will not be repeated again in the present embodiment.

Obviously, a person skilled in the art shall understand that all of the described modules or steps in the present disclosure may be implemented by using a general computing apparatus, may be centralized on a single computing apparatus or may be distributed on a network consisting of multiple computing apparatuses, and may be implemented by using executable program codes of the computing apparatus. Thus, the described modules or steps may be stored in a storage apparatus and executed by the computing apparatus. In addition, in some cases, the shown or described steps may be executed in a sequence different from that shown herein, or they are manufactured into integrated circuit modules, or multiple modules or steps therein are manufactured into a single integrated circuit module. Thus, the present disclosure is not limited to any specific hardware and software combinations.

The content above merely relates to preferred embodiments of the present disclosure and is not intended to limit some embodiments of the present disclosure. For a person skilled in the art, some embodiments of the present disclosure may have various modifications and variations. Any modifications, equivalent replacements, improvements, etc. made within the spirit and principle of the present disclosure shall fall within the scope of protection of the present disclosure.

1. An access acceleration system for a storage device, comprising a central processing unit, a Peripheral Component Interconnect Express (PCIe) device, a storage device, a computing chip, and memories;
wherein the PCIe device comprises a root complex device, a PCIe switch, and a PCIe endpoint;
the central processing unit is in communication connection with an upstream port of the PCIe switch through the root complex device, the storage device is in communication connection with a downstream port of the PCIe switch, the computing chip is in communication connection with a downstream port of the PCIe switch through the PCIe endpoint, and the storage device and the computing chip are in communication connection with different downstream ports of the PCIe switch, respectively; and
the central processing unit and the computing chip are electrically connected to different one of the memories.

2. The system according to claim 1, wherein the system further comprises:
a network interface card, in communication connection with a downstream port of the PCIe switch, wherein the network interface card, the storage devices, and the computing chip are in communication connection with different downstream ports of the PCIe switch, respectively.

3. The system according to claim 1, wherein the system comprises at least one host unit and at least one computing unit;
each host unit of the at least one host unit comprises one said central processing unit, one said root complex device, and one memory of the memories;
each computing unit of the at least one computing unit comprises at least one said PCIe switch, a plurality of said storage devices, at least one said computing chip, at least one said PCIe endpoint, and at least one memory of the memories;
each root complex device is in communication connection with the PCIe switch of the at least one computing unit; and
in the each computing unit, each PCIe switch that is in communication connection with the root complex device is in communication connection with the plurality of storage devices, each computing chip is in communication connection with the at least one PCIe switch through the at least one PCIe endpoint, and the at least one computing chip is electrically connected one-to-one to the at least one memory.

4. The system according to claim 3, wherein at least one of the at least one computing unit comprises a plurality of PCIe switches and a plurality of computing chips, and in the same computing unit, the PCIe switches correspond to the computing chips on a one-to-one basis.

5. The system according to claim 4, wherein,
each PCIe switch in the same computing unit is in communication connection with the root complex device; and
in the same computing unit, a plurality of PCIe endpoints that are in communication connection with any one of the computing chips are in communication connection with a plurality of downstream ports of one of the PCIe switches on a one-to-one basis.

6. The system according to claim 3, wherein the at least one PCIe switch in the each computing unit comprises at least one first PCIe switch and at least one second PCIe switch;
each first PCIe switch of the at least one first PCIe switch has a first upstream port and a plurality of first downstream ports, the first upstream port being in communication connection with the root complex device, at least one of the first downstream ports being in communication connection with corresponding one computing chip of the at least one computing chip through at least one of the at least one PCIe endpoint, the at least one of the first downstream ports corresponding to the at least one of the at least one PCIe endpoint on a one-to-one basis, and each of the remaining first downstream ports being in communication connection with corresponding one of the storage devices; and
each second PCIe switch of the at least one second PCIe switch has at least one second downstream port, each of the at least one second downstream port being in communication connection with corresponding one computing chip of the at least one computing chip through corresponding one of a portion of the at least one PCIe endpoint, the at least one second downstream port corresponding to the portion of the at least one PCIe endpoint on a one-to-one basis.

7. The system according to claim 6, wherein the remaining first downstream ports of the each first PCIe switch are in communication connection with the same number of storage devices.

8. The system according to claim 6, wherein the at least one second downstream port of the each second PCIe switch is in communication connection with the corresponding one computing chip through the same number of PCIe endpoints.

9. The system according to claim 8, wherein in the each computing unit, each computing chip of the at least one computing chip is in communication connection with corresponding one first PCIe switch of the at least one first PCIe switch through a plurality of first PCIe endpoints, and the each computing chip is in communication connection with a plurality of second PCIe switches of the at least one second PCIe switch through a plurality of second PCIe endpoints the plurality of the second PCIe switches corresponding to the plurality of the second PCIe endpoints on a one-to-one basis.

10. The system according to claim 9, wherein in the each computing unit, the numbers of the first PCIe endpoints and the second PCIe endpoints that are in communication connection with the same computing chip are same.

11. The system according to claim 9, wherein in the each computing unit, the each computing chip is in communication connection with the same number of the first PCIe endpoints and the second PCIe endpoints.

12. The system according to claim 9, wherein in the each computing unit, the number of second PCIe endpoints that are in communication connection with each of the second PCIe switches is the same as the number of the at least one computing chip.

13. The system according to claim 6, wherein the system further comprises:
fabric ports, each of the fabric ports being integrated into corresponding one of a plurality of PCIe switches of the at least one PCIe switch, the fabric ports being configured to support transmission between one PCIe switch into which a fabric port of the fabric ports is integrated and another PCIe switch into which a fabric port of the fabric ports is integrated.

14. The system according to claim 13, wherein the at least one computing unit in the system comprises a plurality of first computing units, each of the first computing units has a first fabric port integrated into the first PCIe switch, and first fabric ports in different first computing units are in communication connection with each other.

15. The system according to claim 14, wherein a first target computing unit of the plurality of first computing units is in communication connection with at least one second target computing unit among the plurality of first computing units except the first target computing unit through the first fabric port, and first fabric ports in the first target computing unit correspond to first fabric ports in the at least one second target computing unit on a one-to-one basis.

16. The system according to claim 13, wherein the at least one computing unit in the system comprises a plurality of second computing units, each of the second computing units has a second fabric port integrated into the second PCIe switch, and second fabric ports in different second computing units are in communication connection with each other.

17. The system according to claim 16, wherein a third target computing unit of the plurality of second computing units is in communication connection with at least one fourth target computing unit among the plurality of second computing units except the third target computing unit through the second fabric port, and second fabric ports in the third target computing unit correspond to second fabric ports in the at least one fourth target computing unit on a one-to-one basis.

18. The system according to claim 13, wherein the at least one computing unit in the system comprises a third computing unit, the third computing unit has at least one first fabric ports integrated into the at least one first PCIe switch and at least one second fabric ports integrated into the at least one second PCIe switch, both the at least one first fabric ports and the at least one second fabric ports are switchable ports, and when a first fabric port of the at least one first fabric ports is switched to a second upstream port, and a second fabric port of the at least one second fabric ports is switched to a third downstream port, at least one second upstream port is in communication connection with at least one third downstream port on a one-to-one basis.

19. The system according to claim 18, wherein the at least one computing unit in the system comprises a plurality of third computing units, the second PCIe switch is integrated with the switchable ports and a third fabric port, and third fabric ports in different third computing units are in communication connection with each other.

20. The system according to claim 19, wherein a fifth target computing unit of the plurality of third computing units is in communication connection with at least one sixth target computing unit among the plurality of third computing units except the fifth target computing unit through the third fabric port, and third fabric ports in the fifth target computing unit correspond to third fabric ports in the at least one sixth target computing unit on a one-to-one basis.
